(19) United States
(12) Patent Application Publication
(10) Pub. No.: US 2013/0002199 A1
(43) Pub. Date: Jan. 3, 2013

(54) Charging of Li-ion Batteries

(76) Inventors: Ran Hu, West Hartford, CT (US); Elik Dvorkin, New Haven, CT (US); Robert Pavlinsky, Oxford, CT (US)

(21) Appl. No.: 13/171,721

(22) Filed: Jun. 29, 2011

(51) Int. Cl. H02J 7/04; H02J 7/00

(52) U.S. Cl. 320/112; 320/162

(57) ABSTRACT

Techniques for charging a rechargeable battery having at least one rechargeable cell are described. A battery charger applies a constant current to charge the rechargeable cell and periodically measures a value of voltage of the rechargeable cell. The value of voltage is tracked over a time period required to charge the rechargeable cell to have the measured value of voltage be substantially equal to a crossover value of voltage for the rechargeable cell. A constant voltage is applied substantially equal to the crossover voltage for a second period of time, with the second period of time selected based on the tracked time period. The charging is terminated after the second period of charging time has elapsed.

### BACKGROUND

Lithium ion batteries are generally charged by a combined constant current and constant voltage technique. The batteries are first charged at a constant current until the battery voltage reaches a set voltage value, typically called the cross-over voltage. After this voltage is reached, the charger maintains a constant charge voltage as current tapers down. The charger will keep charging until a termination current value is reached (typically a current that corresponds to 5-10% of the CC rate current). Normally, the charger requires charging circuitry to maintain tight tolerances on voltage and current regulation. In order to support this type of charging, a current sensing circuit is generally used. However current sensing adds significant cost, e.g., current-sensing precision shunt-resistor and an operational amplifier to amplify the low-voltage signal as conventionally used.

One factor limiting the expediency of the charging rechargeable batteries is the danger of the charger and/or battery overheating. Such overheating may damage the charger and/or battery and may pose a safety risk. Consequently, conventional chargers are configured to apply charging current corresponding to charge rates of about 1C. To protect against overheating conditions, temperature sensors are sometimes used to monitor the temperature of the charger and/or the battery, thus enabling the charger to undertake remedial or preemptive actions in the event of the detection of overheating conditions (e.g., terminating the charging current if the battery's temperature exceeds a safety limit of, for example, 45° C.)

### SUMMARY

Disclosed is charger configured to charge a rechargeable battery and provide correct CV mode charge termination. For some battery chemistry types charging can occur in less than 15 and typically in approximately 4-6 minutes to approximately 90-95% capacity.

In an aspect, a method for charging a rechargeable battery having at least one rechargeable cell includes applying by a battery charger, a constant current to charge the at least one rechargeable cell, periodically measuring by a controller device a value of voltage of the rechargeable cell, tracking by the controller device a time period required to charge the rechargeable cell to have the measured value of voltage of the rechargeable cell be substantially equal to a crossover value of voltage for the rechargeable cell, applying a constant voltage substantially equal to the crossover voltage for a second period of time, with the second period of time selected based on the tracked time period, and terminating by the charger the charging current after the second period of charging time has elapsed.

The follow are embodiments within the scope of this aspect.

The method includes periodically adjusting the charging current after the crossover voltage at terminals of the rechargeable battery is reached to maintain the voltage between terminals of the rechargeable battery at the crossover voltage. The method includes causing an output indicator device to be activated when the crossover voltage at terminals of the rechargeable battery is reached. The method includes determining by the controller device the second charging period by using the tracked time to access a table stored in a computer readable storage medium accessible by the microcontroller device to provide the second value of time. The crossover voltage of the rechargeable battery corresponds to approximately 3.8 V for a lithium titanate anode material and lithiated-iron-phosphate cathode materials or 4.2 V for Lithium Cobalt Oxide anode material. Applying the charging current is performed without monitoring temperatures of the rechargeable battery. Regulating the current provided by the power conversion module includes regulating the operation of the voltage transformer section. The rechargeable battery is a rechargeable lithium-iron-phosphate-based battery. Applying the charging current comprises regulating current provided by a power conversion module having a voltage transformer section.

In an additional aspect, a method of manufacturing of a battery charger includes charging a battery at an initial state of charge in a constant current mode by applying a constant current to the battery, tracking time required to have the battery reach a crossover voltage of the battery, charging the battery at the crossover voltage in a constant voltage mode till the battery is at or substantially at full charge, tracking time required to have the battery reach full charge or substantially full charge, repeating the charging steps and the tracking steps for a plurality of different states of charge, producing charging circuitry comprising a controller and associated memory circuitry and storing a table in the memory circuitry, the table relating charging time in constant current mode to charging time in constant voltage mode.

The follow are embodiments within the scope of this aspect.

The battery is a first battery of a first battery type and the method includes repeating charging and tracking steps for a plural different states of charge for at least one additional different combination of battery chemistry and battery construction for a corresponding at least one additional, different battery type, providing at least one additional table in the memory circuitry, the at least one additional table relating charging time in constant current mode to charging time in constant voltage mode for the at least one additional battery type.

In an additional aspect, a charger device to charge one or more rechargeable batteries, the device includes a receptacle to receive one or more rechargeable batteries, the receptacle having electrical contacts configured to be coupled to respective terminals of the one or more rechargeable batteries; and a controller. The controller is configured to apply by the charger a constant current to charge the rechargeable cell, measure a value of voltage of the rechargeable cell, track time required to charge the rechargeable cell to have the measured value of voltage substantially equal to a crossover voltage for the battery, apply a constant voltage substantially at the crossover voltage for a second period of time, the second period of time selected in accordance with the tracked time, and terminate the charging current after the second period of charging time has elapsed.

The follow are embodiments within the scope of this aspect.

The controller is further configured to periodically adjust the charging current after a pre-determined voltage level at terminals of the rechargeable battery is reached to maintain the voltage between terminals of the rechargeable battery at the pre-determined voltage level. The controller is further configured to cause an output indicator device to be activated when the pre-determined voltage level at terminals of the rechargeable battery is reached. The controller is further configured to select the value for the second charging period by using the tracked time to access a table stored in a computer readable memory device accessible by the controller to retrieve the second value of time. The device includes a power conversion module the power conversion module comprising a voltage transformer. The device comprises a feedback control mechanism to cause the controller to regulate current outputted by the power conversion module. The feedback control mechanism is configured to regulate the operation of the voltage transformer. The device feedback control mechanism is configured to maintain the voltage at the terminals of the one or more rechargeable batteries at a pre-determined upper limit voltage, after the voltage at the one or more batteries reaches the pre-determined upper-limit voltage level. The device includes an output indicator device; and with the controller configured to cause the output indicator device to be activated when the pre-determined voltage level at terminals of the rechargeable battery is reached. The device is configured to charge one or more lithium-iron-phosphate-based rechargeable batteries.

In an additional aspect, a computer program product residing on a computer readable storage device for controlling a battery charger, the computer program product comprising instructions for causing a controller in the charger device to cause applying of a constant current to charge a rechargeable cell to a pre-determined value of voltage, periodically measure voltage of the rechargeable cell, track a time period required to charge the rechargeable cell to have the measured value of voltage of the rechargeable cell be substantially equal to the pre-determined value of voltage, cause applying of a constant voltage substantially equal to the pre-determined value of voltage for a second period of time, with the second period of time selected based on the tracked time period, and cause a termination of the charging current after the second period of charging time has elapsed.

The follow are embodiments within the scope of this aspect.

The computer program product includes instructions to periodically adjust the charging current after the pre-determined voltage level at terminals of the rechargeable battery is reached to maintain the voltage between terminals of the rechargeable battery at the pre-determined voltage level. The computer program product includes instructions to determine the second charging period by using the tracked time to access a table stored in a computer readable storage medium accessible by the controller device to provide the second value of time.

One or more aspects may provide one or more of the following advantages.

The relatively low internal resistance of e.g., lithium-iron-phosphate batteries permit such batteries can be charged over short periods of time. The charger is configured to correctly terminate the charging operation after a specified time period has elapsed without having to perform any checks to determine the charge or voltage level of the battery or to perform thermal monitoring and/or thermal control operations. Charging of Li-ion batteries is terminated correctly through estimation of the time needed for the charger to be in constant voltage charging mode by measuring the duration of a preceding constant current charge mode.

This configuration minimizes the circuitry needed in the charger, such as current sensing and current feedback circuitry. In addition, thermal heat sinking requirements can be reduced or eliminated. These advantages can provide reductions in both cost and size of the charger. These advantages are provided while reducing costs and sizes of such charger circuits, yet providing such charger circuits with similar performance characteristics compared to more complex, conventional charger circuits. Cost reduction is achieved by removal of current sensing and control in the charger by use of a reliable technique for terminating charging of Li-ion batteries. Due to the nature of batteries based on lithium chemistry, fast-charging can reach in as much as 10C-15C charge current rate or more (where 1C rate equals 1 h charging rate).

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an exemplary embodiment of a charger.

FIG. 2 is a flow chart of an exemplary embodiment of a charging procedure performed by the charger of FIG. 1.

FIG. 3 is a graph of voltage vs. time for different initial states of charge.

FIG. 4 is a graph of percent initial state of charge vs. voltage.

### DETAILED DESCRIPTION

Electrochemical cells can be primary cells or secondary cells. Primary electrochemical cells are meant to be discharged, e.g., to exhaustion, only once, and then discarded. Primary cells are not intended to be recharged. Primary cells are described, for example, in David Linden, Handbook of Batteries (McGraw-Hill, 2d ed. 1995). On the other hand, secondary electrochemical cells, also referred to below as rechargeable cells or batteries, can be recharged many times, e.g., fifty times, a hundred times, and so forth. Secondary cells are described, e.g., in Falk & Salkind, “Alkaline Storage Batteries”, John Wiley & Sons, Inc. 1969; U.S. Pat. No. 345,124; and French Patent No. 164,681, all hereby incorporated by reference.

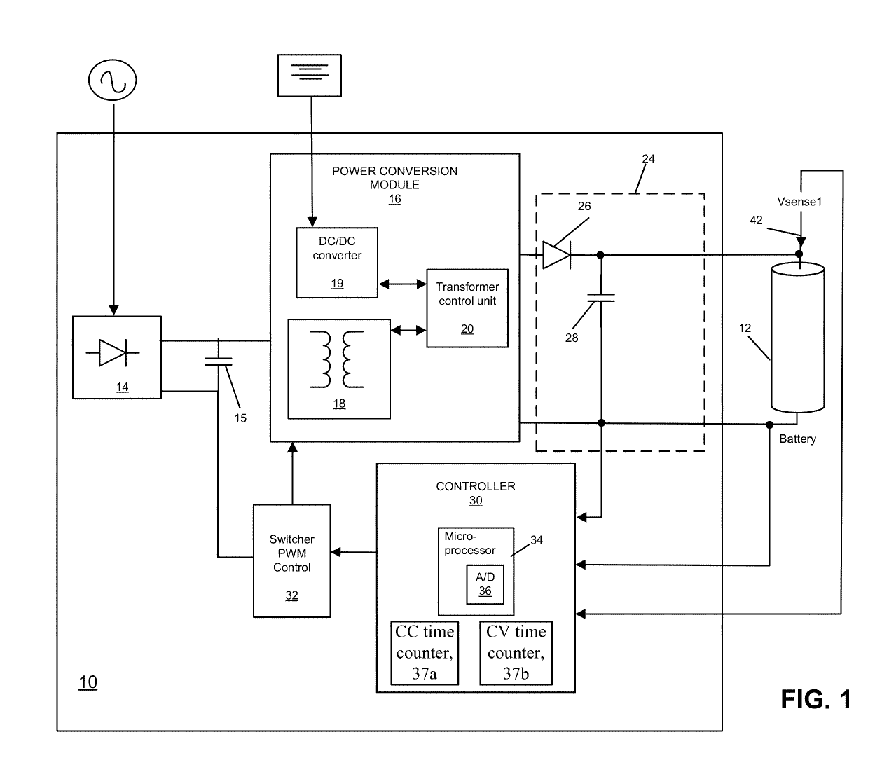

Referring to FIG. 1, a charger 10 configured to charge a rechargeable battery 12 having at least one rechargeable electrochemical based on lithium-iron-phosphate chemistry is shown. Such a battery (which is sometimes referred to as a secondary battery) includes cells having, in some embodiments, lithium titanate anode material, and lithiated-iron-phosphate cathode materials adapted to enable fast recharge of rechargeable batteries based on such materials. Lithium-iron-phosphate chemistry has low internal resistance (R). Thermal dissipation resulting from the internal resistance of such batteries is proportional to I²R (where I is the charging current applied to the battery). Because of the low internal resistance of batteries based on lithium-iron-phosphate chemistry, such batteries can accept high charging currents.

The use of a large charging current to charge a battery based on lithium-iron-phosphate chemistry generally results in the battery achieving 90-95% charge capacity within five (5) minutes, or so. The charger 10 is configured to correctly terminate the charging operation after a time period has elapsed without having to perform any checks to determine the charge or voltage level of the battery, or to perform thermal monitoring and/or thermal control operations. The charger 10 uses two timers, a CC time counter 37a and a CV time counter 37b to measure the duration of two, distinct charging time periods. The first timer, the CC time counter 37a is used to measure the amount of time that the charger 10 is in constant current mode while charging the battery at a constant current. The second timer CV time counter 37b is used to measure the amount of time that the charger 10 stays in constant voltage mode. In the CV charging mode, the CV time counter is decremented. The charger 10 terminates the CV charging mode and overall charging operation when the CV time counter 37b reaching zero. The initial value of the CV time counter is a pre-specified time period that is determined by the first charge period, as discussed below.

Although FIG. 1 shows a single battery 12 connected to the charger 10, the charger 10 may be configured to have additional batteries connected to it. Further, the charger 10 may be configured to receive and charge different battery types including cylindrical batteries, prismatic batteries, coin or button batteries, etc.

The charger 10 is configured to apply only a constant voltage to the battery, but employs a maximum power limiting circuit. The maximum power limiting circuit is placed on the line-referenced side of the isolation barrier in the case of an AC-powered charger. Upon commencement of the charging operation, the charger will provide substantially constant current regulation using the maximum power limiting circuit until the battery voltage reaches the cross-over voltage. During the period that a constant current is delivered to the battery, (i.e., the charger 10 operating in constant current, or CC mode) the voltage of the battery 12 increases. The charger 10 measures this voltage and tracks the amount of time that the charger 10 is in CC charging mode. When the voltage of the battery reaches a pre-determined upper limit voltage of, for example, 3.8V for lithium titanate anode material and lithiated-iron-phosphate cathode materials or 4.2 v for Lithium Cobalt Oxide (this upper limit voltage is sometimes referred to as the crossover voltage), the CC time counter 37a is stopped and its value is saved. The charger 10 is thereafter configured to maintain the battery's voltage at that upper limit voltage for the remainder of the charging period. The time period over which the remainder of the charging operation takes place, that is the duration of the CV charging mode is preset based on the value of the tracked time that the charger 10 spent in CC mode. During this remainder period, the charger 10 applies to the battery 12 a constant voltage substantially equal to the pre-determined crossover voltage value. In this mode, the charger 10 is said to be operating in constant voltage, or CV charging mode.

The charging operation terminates this CV mode after the period of time preset for the duration of the CV mode has elapsed. Because the charger 10 is configured to unconditionally terminate the charging operation at the period of time preset for the duration of the CV mode has elapsed, during which a significant rise in the temperature of the battery and/or of the charger 10 is unlikely, in some embodiments, it is not necessary to monitor the temperature of the battery 12 and/or the charger 10. Accordingly, in embodiments in which thermal monitoring and control operations are not performed, the charger 10 is more physically compact and the circuitry is simplified.

As further shown in FIG. 1, in some embodiments, the charger 10 is implemented such that current/voltage regulation is performed directly on the charger's power conversion section (e.g., the power conversion module 16 shown in FIG. 1) using, for example, a feedback control mechanism (such a configuration is sometimes referred to as primary-side voltage/current regulation.) In other words, the control mechanism regulates the switching frequency or pulse duration of the power conversion module 16, thus regulating the output voltage and current of the converter. Accordingly, in such embodiments, the charger 10 does not include multiple voltage conversion modes (e.g., an AC/DC conversion mode followed by, for example, a buck converter circuit), and as a result, the charger 10 can reduce power losses that are generally sustained in multi-mode power conversion circuit. By implementing primary-side voltage/current control, power efficiency (e.g., the percentage of input power ultimately delivered to the output of the power conversion circuit) is typically in the range of 80-90%. In contrast, a two-mode power conversion circuit generally achieves 80-90% efficiency per mode, and thus the overall power efficiency for a two-mode power conversion circuit is generally in the range of 60-80%. These losses in power efficiency are expressed as heat dissipation in the power conversion modes.

The charger 10 includes a rectifier module 14 that is electrically coupled to an AC power source such as a source providing power at a rating of 85V-265V and 50 Hz-60 Hz. The rectifier module 14 includes a diode-based full wave bridge rectifier. A capacitor 15 stores energy for the power conversion module 16. Coupled to the rectifier module 14 is the power conversion module 16 that includes a transformer 18 and a transformer control unit 20 to facilitate regulation of the operation of the transformer 18. In some embodiments, the power conversion module 16 is implemented as a switcher converter in which the desired voltage level at the output of the power conversion module 16 is achieved by switching the power conversion module 16 on and off During the switcher's on-period, a voltage is provided at the output of the power conversion module 16, and during the off-period, no voltage is provided at output terminals of the power conversion module 16. Such a switcher converter is implemented using discrete transistors (e.g., MOSFET transistors), or using a suitable integrated circuit (IC) to perform the switching operation.

The use of the rectifier module 14 coupled to the power conversion module 16 causes AC power provided at the input to the charger 10 to be converted to a low D.C. voltage suitable for charging rechargeable batteries, e.g., DC voltages at levels of approximately between 3.7-4.2V.

In some embodiments, an additional DC-DC converter 19 is incorporated into the power conversion module 16 to convert an external DC power source, such as a car's DC power supply, to a DC power level suitable for charging rechargeable batteries. For example, a car's DC power supply supplies DC power at approximately 11V to 14.4V, and the DC-DC converter 19 converts that voltage level to a suitable voltage level. The added DC-DC converter can be configured to accept DC power sources having various output voltages, e.g., in the range of 1.2V to approximately 24V. Thus, in some embodiments the DC-DC converter is an up-converter, increasing the voltage of 1.2V to the DC charging voltage of 3.7 to 4.2 volts, whereas in those applications above 4.2 voltages the converter is a down converter.

Electrically coupled to the output of the power conversion module 16 is a filter circuit 24 that includes a diode 26 connected in series with a capacitor 28. The filter circuit 24 is configured to reduce current/voltage ripples at the output of the power conversion module 16. The filter circuit 24 is also configured to discharge energy stored in the capacitor 28 into the battery 12 during off-periods when no current is provided at the output of the power conversion module 16. Thus, current provided by the power conversion module 16 during its on-periods and the current provided by the capacitor 28 during the off-periods of the power conversion module 16 results in an effective current substantially equal to a desired charging current to be applied to the battery 12. The diode 26 is connected so that current discharged by the capacitor 28 is directed to the battery 12 and not into the power conversion module 16.

To control the current and/or voltage level applied to the battery 12, a feedback mechanism is provided. The feedback mechanism includes a controller 30 to regulate the DC output voltage of the power conversion module 16. The power conversion module 16 is coupled to the output terminals of charger 10 (and thus to the terminals of the battery 12) through which the charging current is applied. The controller 30 is electrically coupled to a switcher Pulse Width Modulation (PWM) control unit 32 that receives control signals from the controller 30, and generates in response, pulse width modulated signals that are provided to the transformer control unit 20 to cause the power conversion module 16 to provide voltage at its output. The PWM control unit 32 limits the power delivered at the output of the converter to below a maximum power threshold, effectively provided constant current charging. An example of a primary-side switching controller is PWM 3845 (Analog Devices). The PWM control unit 32 controls the current on the secondary side, while the secondary-side circuit drives feedback simply to regulate the output voltage to the CV value. When the voltage of the cell is below the CV value, the feedback is saturated and the converter circuit runs at maximum output and is configured to limit the maximum current over the input and output voltage ranges to be within a range that is permissible by the battery. Once the battery voltage reaches the CV value, the feedback signal retreats from saturation and the secondary-side charging circuitry begins to regulate the output voltage, as in a typical charger.

The controller 30 includes a micro controller or microprocessor and the CC and CV time counters 37a and 37b respectively, implemented either in hardware, software or firmware, and memory to store a program to control the controller or processor, and an A/D converter.

When the pulse width modulated signals are withdrawn, the transformer control unit 20 causes the voltage to be withdrawn from the output of the power conversion module 16. Thus, by comparing the current feedback voltage to a pre-set value and controlling the operation of switcher PWM control unit 32, and thus controlling the operation of the power conversion module 16, the controller 30 causes a current substantially equal to the charging current to be applied to the battery 12. Constant current is applied to the battery for a period of time. This period of time is tracked and recorded by the controller 30 using the CC time counter 37a. When the value of the voltage of the battery reaches the cross-over value of, e.g., 3.8 or 4.2, etc. depending on battery chemistry, the controller changes into a constant voltage mode from a constant current mode. The controller 30 accesses a table stored in memory associated with the controller 30 and using the value of the tracked period of time from CC time counter 37a to access a second value of time that is loaded by the controller 30 into the CV time counter 37b. During the CV charging mode, the CV time counter 37b is decremented. When the CV time counter 37b reaches zero, the constant voltage charging mode is terminated and charging is complete. Alternatively, rather than decrementing a counter, the time period in the CV charging mode can be tracked in other ways, such as determining when the period of time in the CV charging mode equals the value accessed from the table.

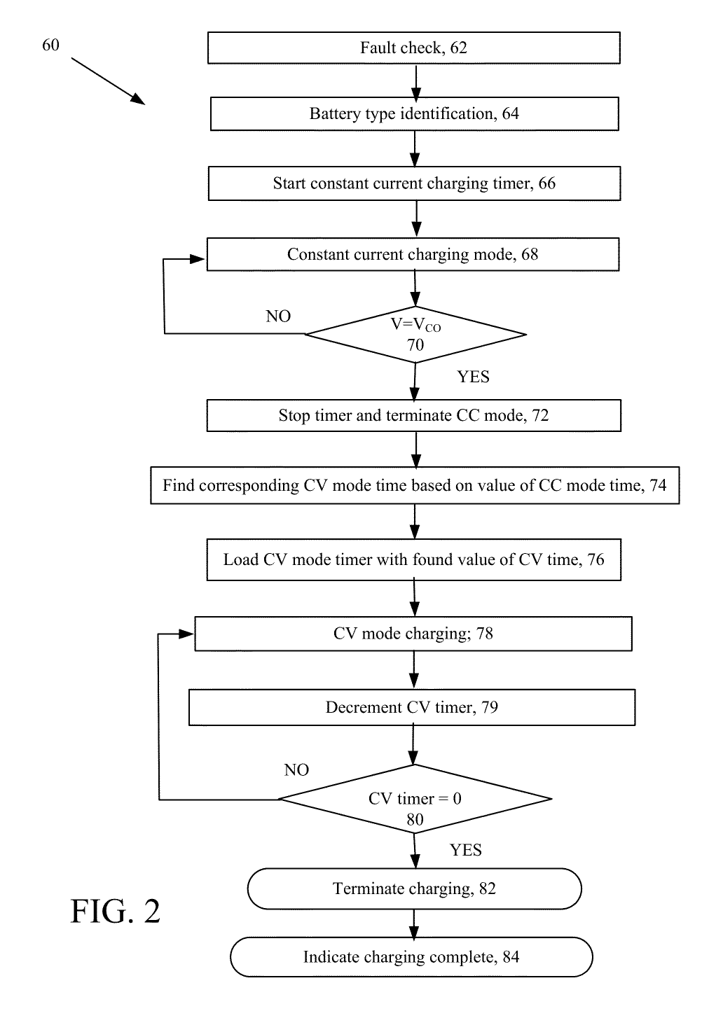

Referring now to FIG. 2, the controller 30 is configured to control the operation of the charger 10 as follows: After placing the battery 12 in the charger's charging compartment, the charger 10 may optionally determine 62, prior to commencing the charging operations, whether certain fault conditions exist. Thus, for example, the charger 10 measures the voltage of the battery 12. The charger 10 determines whether the measured voltage V₀ is within a predetermined range (e.g., that V₀ is between 2-3.8V) In circumstances in which it is determined that the measured voltage is not within the predetermined acceptable ranges thus rendering a charging operation under current conditions to be unsafe or unnecessary, the charger 10 does not proceed with the charging operation, and the procedure may terminate.

If no faults exist or if no fault programming is provided, the charger 10 determines 64 battery type if the charger 10 is adapted to receive different types of batteries of different capacities/chemistries. The charger 10 determines the capacity and/or type of the battery 12 inserted into the charging compartment of the charger 10.

The controller 30 enters the constant current charging mode. The controller starts 66 the first timer (CC time counter 37a FIG. 1), which tracks the time the charger 10 spends in the constant current mode and charges 68 the battery at the determined constant current. The controller 30 determines the approximate existing charge level of the battery 12 by measuring the voltage of battery. If the value of the measured voltage (V) is equal to 70 the crossover voltage (V_{CO}) for the particular battery chemistry, the controller 30 stops the CC time counter 37a and terminates 72 the CC mode. Otherwise, the controller continues charging 68 the battery in the constant current mode until the value of the measured voltage (V) is equal to the crossover voltage (V_{CO}) 70.

When the value of the measured voltage (V) is equal to the crossover voltage (V_{CO}) and the CC mode has thus been terminated, the controller 30 uses 74 the value of the CC time counter 37a to access a value of time to start the CV time counter 37b. This value of time for the CV time counter 37b is loaded 76 into the CV time counter 37b and the controller 30 charges 78 the battery at the crossover voltage for a period of time and decrementing 79 the CV time counter 37b. When the value of the CV time counter 37b equals zero 80, the controller terminates the CV mode and thus terminates 82 charging of the battery. At that juncture, the controller can produce 84 an indication of charger 10 termination (completion of charging cycle).

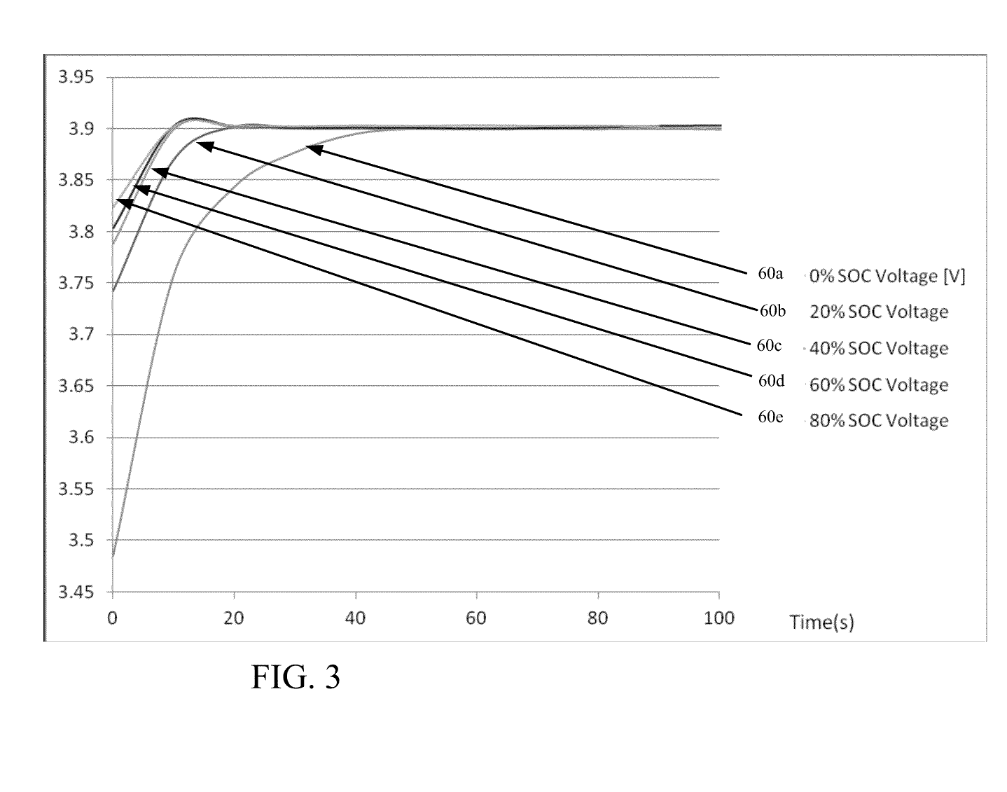

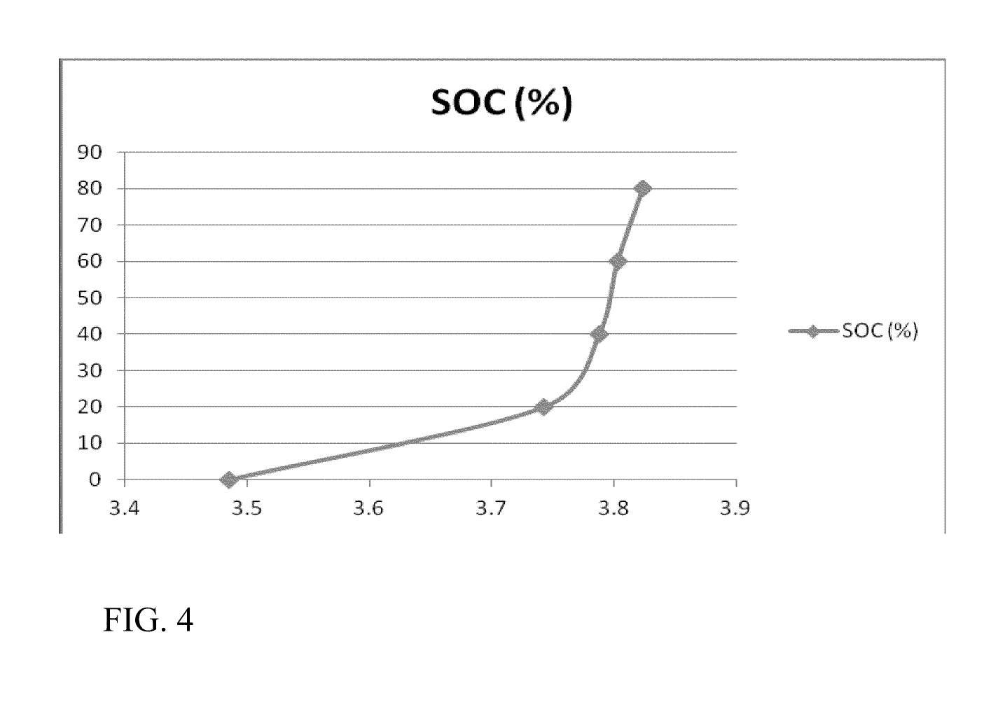

Initial values for the CV time counter 37b for different values of the CC time duration are determined empirically by careful characterization of the battery chemistry-construction. Batteries at lower initial states of charge (SOC) spend more time in the constant voltage mode to compensate for lost energy. That is, time spent in CV mode is inversely-proportional to the initial SOC (as shown in FIG. 3). For example, for one type of LiFePO battery such a battery at 0% SOC can be in CC mode for around 60 sec and in CV mode for 240 sec; while a battery at 20% SOC can be in CC mode for around 25 sec and in CV mode for 180 sec. For a battery at 50% SOC and above there might be no CC mode and the charger 10 after measuring the initial (state of charge) will directly go to CV mode. The time spent in constant voltage mode to fully charge the battery depends on the battery initial SOC. Moreover, the voltage of the battery will vary according to the initial state of charge (SOC) of the battery, as illustrated in FIG. 4. Other periods of time are possible and indeed likely depending on the chemistry of the battery and possibly construction details of the battery.

For each battery in a set of battery types (combinations of battery chemistries and in some embodiments construction details), multiple voltage vs. time charging profiles are recorded for each different type in the set of battery types for different initial SOC's. Through various trials and knowledge of the battery chemistry, a set of values are provided for each type. These values for each type are programmed into the controller in the form of, e.g., a table in the program for instance, and used by the controller to properly terminate the CV mode, as discussed above. Various tables can be provided if the charger 10 is configured to charge various battery types.

Each battery type (where the charger 10 is configured to handle various battery types) has a corresponding table. When the charger 10 is for a single battery type, a single table is used.

| Time spent in CC mode | Time to spend in CV mode |
|---|---|
| T_{CC1} | T_{CV1} |
| T_{CC2} | T_{CV2} |
| T_{CC3} | T_{CV3} |
| T_{CC4} | T_{CC4} |
| * * * | * * * |
| T_{CCn-1} | T_{CVn-1} |
| T_{CCn} | T_{CVn} |

The number of levels (rows in the table) depends on the degree of granularity desired or required taking into consideration the shape of the SOC v. voltage characteristic of the battery type (FIG. 4). In some embodiments, the controller can be programed to charge various battery types and the determination of the time to spend in the CV mode is performed by identifying the battery type placed in the charging compartment (not shown) of the charger 10 using, for example, an identification mechanism that provides data representative of the battery type. This type identification would then be used to select the proper table from multiple tables programmed in the controller.

A detailed description of an exemplary charger 10 device that includes an identification mechanism based on the use of an ID resistor having a resistance representative of the battery's capacity is provided in co-pending patent application entitled “Ultra Fast Battery Charger with Battery Sensing” Ser. No. 11/776,261, filed Jul. 11, 2007, by Jordan T. Bourilkov et al. the content of which is hereby incorporated by reference in its entirety. An alternative identification mechanism is described in co-pending application entitled “Single Wire Battery Pack Temperature and Identification Method” Ser. No. 12/981,737, filed Dec. 30, 2010 by Elik Dvorkin et al. the content of which is hereby incorporated by reference in its entirety.

The user interface may also include an input element (e.g., switch) to enable or disable the charger 10. The user interface may also include output indicator devices such as LED's to provide status information to a user regarding the charger 10 and/or battery 12 connected thereto, a display device configured to provide output information to the user, etc. For example, the user interface may include a LED that is illuminated when the charger 10 switches from constant current mode to constant voltage mode. Generally, when the battery's voltage reaches the cross-over point (e.g., between 3.8-4.2V), the battery's charge is typically 80-90% of the battery's charge capacity, and thus is substantially ready for use. The illuminated LED indicates to the user that the battery is at least 80-90% charged, giving the user the option to remove the battery prior to the completion of charging operation if the user requires the battery for some immediate use and does not want to wait for the charging operation to be fully completed.

In some embodiments, the user interface may further include, for example, additional output devices to provide additional information. For example, the user interface may include a red LED that is illuminated if a fault condition, such as an over-voltage, and may include another LED, e.g., a yellow or green LED device, to indicate that the charging operation of the battery 12 is in progress.

As mentioned above and as shown in FIG. 1, the controller 30 includes a processor device 34 configured to control the charging operations performed on the battery 12. The processor device 26 may be any type of computing and/or processing device, such as a PIC18F1320 microcontroller from Microchip Technology Inc. The processor device 34 used in the implementation of the controller 30 includes volatile and/or non-volatile memory elements configured to store software containing computer instructions to enable general operations of the processor-based device, as well as implementation programs to perform charging operations on the battery 12 connected to the charger 10, including such charging operations that achieve at least 90% charge capacity in approximately 5 minutes.

The processor 34 includes an analog-to-digital (A/D) converter 36 with multiple analog and digital input and output lines. The A/D converter 36 is configured to receive signals from sensors (described below) coupled to the battery to facilitate regulating and controlling the charging operation. In some embodiments, the controller 30 may also include a digital signal processor (DSP) to perform some or all of the processing functions of the control device, as described herein.

The charger's various modules, including the rectifier unit 14, the transformer control unit 20, the processor 34, and the switcher PWM control unit 32 may be arranged on a circuit board (not shown) of the charger 10.

The charger 10 determines a charging current to be applied to the rechargeable battery 12 based on the battery chemistry. As explained herein, batteries based on lithium-iron-phosphate electrochemical cells have relatively low internal resistance and thus can be charged with relatively large charging currents in the order of, for example, 10C to 15C, where a charge rate of 10C correspond to a charge current that would charge a rechargeable battery in 6 minutes (1C being the current required to charge a particular rechargeable battery in 1 hour), and a current of 15C is the current required to charge the rechargeable battery in 4 minutes. Because of the low charging resistance of lithium-iron-phosphate batteries, significant heat dissipation is avoided and accordingly such batteries can withstand high charging currents without the battery's performance or durability being adversely affected.

The transistor's on-period, or duty cycle, is initially ramped up from 0% duty cycle, while the controller or feedback loop measures the output current and voltage. Once the determined charging current is reached, the feedback control loop manages the transistor duty cycle using a closed loop linear feedback scheme, e.g., using a proportional-integral-differential, or PID, mechanism. A similar control mechanism may be used to control the transistor's duty cycle once the charger 10 voltage output, or battery terminal voltage, reaches the crossover voltage.

Thus, the current provided by the power conversion module 16 during its on-period, and the current provided by the capacitor 28 during the off-periods of the power conversion module 16 should result in an effective current substantially equal to the required charging current. In some embodiments, controller 30 can periodically receive (e.g., every 0.1 second) a measurement of the current flowing through the battery 12 as measured, for example, by a current sensor 40. Based on this received measured current, the controller 30 adjusts the duty cycle to cause an adjustment to the current flowing through the battery 12 so that that current converges to a value substantially equal to the charging current level.

The charger 10 also includes a voltage sensor 42 that is electrically coupled to the charging terminals of the charger 10. The voltage sensor periodically measures (e.g., every 0.1 seconds) the voltage at the terminals of the battery 12. These periodical voltage measurements enable the controller 30 to control the voltage provided by the power conversion module 16 during the constant voltage (CV) mode so that the voltage applied at the terminals of the battery 12 during the CV mode is at a substantially constant level (e.g., the pre-determined upper-limit voltage.) This CV mode is terminated based upon the value of time loaded into the CV time counter 37b that is decremented.

The current/voltage measured by the sensor 42 may be used to determine if fault conditions exist that require that the charging operation of be terminated, or that the charging operation not be commenced. For example, the controller 30 determines if the voltage measured by the voltage sensor 42 at the terminals of the battery 12 is within a pre-determined range of voltage levels for the battery 12 (e.g., 2 to 3.8V). If the measured value is below the lower voltage limit of the range, this may be indicative that the battery is defective. If the measured value is above the upper limit of the range, this could be indicative that the battery is already fully charged and thus further charging is not required and might damage the battery. Accordingly, if the measured voltage does not fall within the pre-determined range, a fault condition is deemed to exist.

The charger 10 may make a similar determination with respect to the current measured via the current sensor 40, and if the measured current is outside a pre-determined current range, a fault condition may be deemed to exist, and consequently the charging operation would either not be commenced, or would be terminated.

In some embodiments, the received measured signals are processed using analog logic processing elements (not shown) such as dedicated charge controller devices that may include, for example, threshold comparators, to determine the level of the voltage and current level measured by the sensor 42. The charger 10 may also include a signal conditioning block (not shown) for performing signal filtering and processing on analog and/or digital input signals to prevent incorrect measurements (e.g., incorrect measurements of voltages, temperatures, etc.) that may be caused by extraneous factors such as circuit level noise.

In some embodiments, the controller 30 is configured to monitor the voltage increase rate by periodically measuring the voltage at the terminals of the battery 12, and adjust the charging current applied to the battery 12 such that the pre-determined upper voltage limit is reached within some specified voltage rise period of time. Based on the measured voltage increase rate, the charging current level is adjusted to increase or decrease the charging current such that the pre-determined upper voltage limit is reached within the specified voltage rise period. Adjustment of the charging current level is performed, for example, in accordance with a predictor-corrector technique that uses a Kalman filter. Other approaches for determining adjustments to the current to achieve the pre-determined upper voltage limit may be used.

The charger 10 described herein charges batteries, e.g., lithium-iron-phosphate batteries, over relatively short intervals (e.g., 5 minutes), of time. Such a charger typically would not generate significant heat during that short period of operation. Therefore, in some embodiments certain modules and/or components configured to safeguard the operation of conventional chargers to prevent damage and unsafe operation due to the generation of heat may be reduced in capacity or eliminated from the charger 10 entirely. For example, the charger 10 may be constructed without employing thermal control components (e.g., fans, heat sink elements, additional control modules, etc.) and/or without thermal monitoring components (e.g., thermal sensors such as thermistors).

Further, because of the short period of operation of the charger 10 described herein, the physical dimensions of the various components of the charger 10, which frequently are configured to have large surface areas to dissipate generated heat, may be smaller than the components used with conventional chargers. Consequently, such smaller size components may be fitted into smaller size housing, thus resulting in charger devices having physical dimensions that are generally smaller than those of conventional charger devices.

FIG. 3 depicts an exemplary chart of battery voltage vs. time to predict CV-mode charge time. In FIG. 3, five different SOC values are shown. In practice there could be more SOC values or fewer depending on the granularity needed to exactly hit the correct charge time in CV mode for the particular charger.

FIG. 4 depicts an exemplary chart of battery initial SOC vs. voltage, which shows the battery voltage that, corresponds to a particular initial charge state.

Determining Battery Type

In some embodiments, the charger 10 includes an identification mechanism configured to measure the resistance of an ID resistor, whose resistance value is indicative of the capacity and/or type of the battery 12 mechanisms to accomplish this are mentioned above. Additionally and/or alternatively, the capacity and/or type of the battery 12 may be communicated to the charger 10 via a user interface disposed, for example, on the body of the charger 10. The data communicated via the identification mechanism, user interface, or otherwise, is thus representative of the battery's capacity and/or type. The charger 10 can thus determine the appropriate timing table to use based on this data.

The current/voltage applied by the power conversion module 16 is controlled 60 to cause a constant current to be applied to the rechargeable battery 12. As explained, the charger 10 implements a primary-side feedback mechanism that includes the controller 30 and the switcher PWM control unit 32, that operates to adjust the current/voltage at the output of the power conversion module 16. During the off-time of the power conversion module 16 (i.e., when current/voltage at the output of the module 16 is withheld), the energy stored in the capacitor 28 is discharged to the battery 12 as a current. The current applied from the power conversion module 16 and the current discharged from the capacitor 28 result in an effective constant charging current.

The battery 12 is charged with the substantially constant current until the voltage at the battery's terminals reaches a pre-determined upper voltage limit. Thus, the voltage at the battery 12 terminals is periodically measured 62 to determine when the pre-determined upper voltage limit (i.e., the crossover voltage) has been reached. When the voltage at the terminals of the battery 12 has reached the pre-determined upper voltage limit, e.g., 4.2V, the power conversion module 16 is controlled (also at 62) to have a constant voltage level substantially equal to the crossover voltage level maintained at the terminals of the battery 12.

Additionally, a LED on the user interface of the charger 10 may illuminate to indicate that the crossover voltage point has been reached, and that therefore the battery has sufficient charge to properly operate. At that point a user may remove the battery 12 if the user desires to immediately use the battery.

After the CV time counter is decremented to zero, substantially equal to the CV charging time period, the charging current applied to the battery 12 is terminated (for example, by ceasing electrical actuation of the power conversion module 16 using the switcher PWM control module 32 and/or the transformer control unit 20).

### Other Embodiments

A number of embodiments of the invention have been described. Nevertheless, it will be understood that various modifications may be made without departing from the spirit and scope of the invention. For instance, the charger 10 can be associated with or embedded within a docking station used with an electronic device, e.g., cell phone, computer, personal digital assistant and so forth. Accordingly, other embodiments are within the scope of the following claims.

What is claimed is:

1. A method for charging a rechargeable battery having at least one rechargeable cell, the method comprising:
applying by a battery charger, a constant current to charge the at least one rechargeable cell;
periodically measuring by a controller device a value of voltage of the rechargeable cell;
tracking by the controller device a time period required to charge the rechargeable cell to have the measured value of voltage of the rechargeable cell be substantially equal to a crossover value of voltage for the rechargeable cell;
applying a constant voltage substantially equal to the crossover voltage for a second period of time, with the second period of time selected based on the tracked time period; and
terminating by the charger the charging current after the second period of charging time has elapsed.

2. The method of claim 1, further comprising:
periodically adjusting the charging current after the crossover voltage at terminals of the rechargeable battery is reached to maintain the voltage between terminals of the rechargeable battery at the crossover voltage.

3. The method of claim 2, further comprising:
causing an output indicator device to be activated when the crossover voltage at terminals of the rechargeable battery is reached.

4. The method of claim 1, further comprising:
determining by the controller device the second charging period by using the tracked time to access a table stored in a computer readable storage medium accessible by the microcontroller device to provide the second value of time.

5. The method of claim 3, wherein the crossover voltage of the rechargeable battery corresponds approximately 3.8 V for a lithium titanate anode material and lithiated-iron-phosphate cathode materials or 4.2 V for Lithium Cobalt Oxide anode material.

6. The method of claim 1, wherein applying the charging current is performed without monitoring temperatures of the rechargeable battery.

7. The method of claim 6 wherein regulating the current provided by the power conversion module includes regulating the operation of the voltage transformer section.

8. The method of claim 1, wherein the rechargeable battery is a rechargeable lithium-iron-phosphate-based battery.

9. The method of claim 1, wherein applying the charging current comprises regulating current provided by a power conversion module having a voltage transformer section.

10. A method of manufacturing of a battery charger, the method comprising:
charging a battery at an initial state of charge in a constant current mode by applying a constant current to the battery;
tracking time required to have the battery reach a crossover voltage of the battery;
charging the battery at the crossover voltage in a constant voltage mode till the battery is at or substantially at full charge;
tracking time required to have the battery reach full charge or substantially full charge;
repeating the charging steps and the tracking steps for a plurality of different states of charge;
producing charging circuitry comprising a controller and associated memory circuitry; and
storing a table in the memory circuitry, the table relating charging time in constant current mode to charging time in constant voltage mode.

11. The method of claim 1 wherein the battery is a first battery of a first battery type, the method further comprising:
repeating charging and tracking steps for a plural different states of charge for at least one additional different combination of battery chemistry and battery construction for a corresponding at least one additional, different battery type;
providing at least one additional table in the memory circuitry, the at least one additional table relating charging time in constant current mode to charging time in constant voltage mode for the at least one additional battery type.

12. A charger device to charge one or more rechargeable batteries, the device comprising:
a receptacle to receive one or more rechargeable batteries, the receptacle having electrical contacts configured to be coupled to respective terminals of the one or more rechargeable batteries; and
a controller configured to:
apply by the charger a constant current to charge the rechargeable cell;
measure a value of voltage of the rechargeable cell;
track time required to charge the rechargeable cell to have the measured value of voltage substantially equal to a crossover voltage for the battery;
apply a constant voltage substantially at the crossover voltage for a second period of time, the second period of time selected in accordance with the tracked time; and
terminate the charging current after the second period of charging time has elapsed.

13. The device of claim 12 wherein the controller is further configured to:
periodically adjust the charging current after a pre-determined voltage level at terminals of the rechargeable battery is reached to maintain the voltage between terminals of the rechargeable battery at the pre-determined voltage level.

14. The device of claim 12 wherein the controller is further configured to:
cause an output indicator device to be activated when the pre-determined voltage level at terminals of the rechargeable battery is reached.

15. The device of claim 12 wherein the controller is further configured to:
select the value for the second charging period by using the tracked time to access a table stored in a computer readable memory device accessible by the controller to retrieve the second value of time.

16. The device of claim 12, further comprising:
a power conversion module the power conversion module comprising a voltage transformer.

17. The device of claim 16 wherein the device comprises a feedback control mechanism to cause the controller to regulate current outputted by the power conversion module.

18. The device of claim 17 wherein the feedback control mechanism is configured to regulate the operation of the voltage transformer.

19. The device of claim 17 wherein the feedback control mechanism is configured to maintain the voltage at the terminals of the one or more rechargeable batteries at a pre-determined upper limit voltage, after the voltage at the one or more batteries reaches the pre-determined upper-limit voltage level.

20. The device of claim 12, further comprising:
an output indicator device; and with the controller configured to:
cause the output indicator device to be activated when the pre-determined voltage level at terminals of the rechargeable battery is reached.

21. The device of claim 12 wherein the device is configured to charge one or more lithium-iron-phosphate-based rechargeable batteries.

22. A computer program product tangibly embodied in a computer readable storage device for controlling a battery charger, the computer program product comprising instructions for causing a controller device to:
cause applying of a constant current to charge a rechargeable cell to a pre-determined value of voltage;
periodically measure voltage of the rechargeable cell;
track a time period required to charge the rechargeable cell to have the measured value of voltage of the rechargeable cell be substantially equal to the pre-determined value of voltage;
cause applying of a constant voltage substantially equal to the pre-determined value of voltage for a second period of time, with the second period of time selected based on the tracked time period; and
cause a termination of the charging current after the second period of charging time has elapsed.

23. The computer program product of claim 22, further comprising instructions to:
periodically adjust the charging current after the pre-determined voltage level at terminals of the rechargeable battery is reached to maintain the voltage between terminals of the rechargeable battery at the pre-determined voltage level.

24. The computer program product of claim 22, further comprising instructions to:
determine the second charging period by using the tracked time to access a table stored in a computer readable storage medium accessible by the controller device to provide the second value of time.
